(19) United States
(12) Patent Application Publication
(10) Pub. No.: US 2006/0169111 A1
(43) Pub. Date: Aug. 3, 2006

(54) Saw blade for drywall, saw apparatus utilizing saw blade and method

(76) Inventor: Kevin M. Kozlowski, Wheaton, IL (US)

Correspondence Address: SCHIFF HARDIN, LLP;PATENT DEPARTMENT, 6600 SEARS TOWER, CHICAGO, IL, 60606-6473, US

(21) Appl. No.: 11/049,161

(22) Filed: Feb. 2, 2005

(51) Int. Cl. B23D 45/16

(52) U.S. Cl. 83/13; 83/100; 83/520; 83/835; 30/388

(57) ABSTRACT

A saw blade for use on a circular saw to cut drywall board is formed of thin metal and includes generally rectangular teeth formed along the perimeter of the saw blade. The saw teeth have an outer edge along a circle centered on a center of the blade and teeth edges substantially perpendicular to the outer edge. The teeth are in the plane of the saw blade. A power saw using the saw blade has a dust collection housing around a portion of the blade with an air filtration apparatus connected to the dust collection housing. A shoe of the power saw is adjustable to vary the cutting depth of the saw blade and a compressible extension of the dust collection housing is in contact with the shoe. A laser line projector is mounted on the saw and projects to a laser line target connected on an edge of the drywall board. The target disengages from the edge of the drywall board upon the saw reaching the target and the target engages the saw. A saw blade for small hand tools is also provided.

### BACKGROUND OF THE INVENTION

1. Field of the Invention

The present invention relates generally to a circular power saw blade and to a saw as well as to a method for sawing wallboard and the like.

2. Description of the Related Art

Modern buildings including homes, offices and other structures often use so-called wallboard for interior wall and/or ceiling surfaces. Such wallboard is known by many names including gypsum board, sheetrock, drywall, or plaster board. Wallboard is comprised of compressed gypsum (calcium sulfate dihydrate) with a craft paper covering on both sides and at the edges. Wallboard may include additional coverings, backings and ingredients such as aluminum foil or fiberglass to provide various characteristics such as providing a vapor barrier. Water resistant wallboard is also known for backing tiles in bathrooms, laundry rooms or kitchens. Wallboard sheathing which includes tongue and groove edges as a support for siding, masonry, stucco or shingles is available for exterior wall surfaces.

The installation of wallboard or drywall is accomplished by cutting the board with a scoring or trimming knife to cut through the outer paper and into the inner core and then breaking the wallboard to break the gypsum core and then trimming the paper or covering on the opposite side with shears or a knife. Openings may be formed into the wallboard for electrical outlets, light fixtures, switches and the like by cutting with a keyhole saw or circular cutter or other type of cutting implement. Power tools may be used to cut the wallboard but these generate significant quantities of fine chalk dust. Even working with rasps or other cutting and shaping tools generates fine dust.

While there are many advantages to using drywall or wallboard in construction, including its sound and thermal installation properties, fire resistance, strength and attractiveness, there are also disadvantages which occur mainly during installation. A primary disadvantage is that working with wallboard generates a significant amount of dust from the gypsum material at the core of the wallboard. Cutting with power tools aggravates the distribution of dust and spreads it into the air and onto all surrounding surfaces.

Cutting wallboard or drywall with a knife, box cutter or other manual cutting implement runs the risk of injury to the user of the knife as well as the chance that the cut will be uneven. Further, cutting the wallboard with a knife only cuts partway through so that additional steps must be taken in order to break, fold over and finish cutting the craft paper on the opposite side. This makes it difficult or impossible to utilize this technique for openings in the wallboard, such as for switches and outlets.

The use of power tools including power saws and manual tools such as rasps not only spreads the gypsum dust widely, but also leaves a tattered and ragged edge on the craft paper at both sides of the cut which must be trimmed prior to finishing. In any event, both manual blade cutting and power tool cutting of the wallboard leaves a rough uneven surface which should be smoothed by a rasp or other shaping instrument, resulting in dust being generated.

### SUMMARY OF THE INVENTION

The present invention provides a circular saw blade as well as a power saw system for cutting wallboard or drywall so as to generate very little dust and provide an even true cut surface. In particular, the present circular saw blade is of a thin strong material including a number of teeth at the outer perimeter of the blade adapted specifically for cutting drywall or wallboard material. A saw and saw accessories utilizing the present blade are provided including a dust collection system and various features to facilitate use of the saw blade to cut drywall or wallboard with little dust generation. A method for cutting wallboard or drywall is also provided.

### BRIEF DESCRIPTION OF THE DRAWINGS

FIG. 1 is a side view of a first embodiment of a saw blade according to the principles of the present invention;

FIG. 2 is a side view of a second embodiment of the present saw blade;

FIG. 3 is a side view of a third embodiment of the saw blade;

FIG. 4 is a perspective view of a circular saw and dust collection system incorporating a dust shield for use in cutting drywall or wallboard using the present saw blade;

FIG. 5 is a perspective view of the power saw having a laser line tool and laser target according to the principles of the present invention;

FIG. 6 is a perspective view of the laser target according to the invention; and

FIG. 7 is a side view of the laser target showing a magnetic catch.

### DETAILED DESCRIPTION OF THE PREFERRED EMBODIMENTS

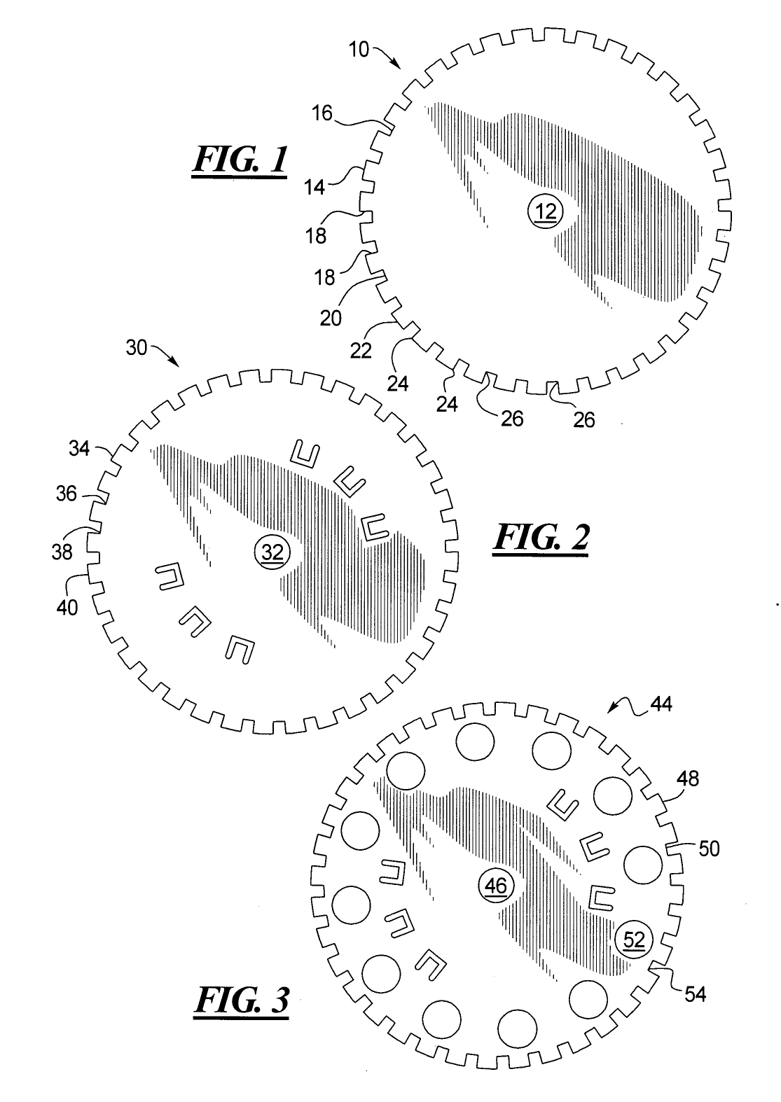

In FIG. 1, a circular saw blade 10 is shown for cutting drywall, wallboard, sheet-rock, dense board, gypsum board or other similar boards or panels. The present saw blade can also be used to cut ceiling tiles, room divider panels or other types of building panels. Reference to wallboard or the like in the present application includes not only drywall panels but also ceiling tiles and other panels. The circular saw blade 10 includes a circular central opening 12 for an arbor of a power saw, or so-called circular saw. Along the perimeter of the saw blade 10 are formed a number of teeth 14 defined by notches 16 cut into the body of the saw blade. In the illustrated embodiment, there are 36 teeth around the circumference of the saw blade 10. The teeth 14 formed by 36 notches. Of course, other numbers of teeth and notches can be provided in other embodiments, including for saw blades of the same size or for saw blades of different sizes. The teeth 14 and notches 16 are in a regularly spaced arrangement around the perimeter of the saw blade 10, although irregular spacing of the teeth and/or notches may be provided in some embodiments.

The teeth 14 lie in the plane of the saw blade 10 and are not bent outward, angled, chisel cut or otherwise formed to extend from the plane of the blade 10. In other words, the teeth 14 have no set. This results in the cut, or kerf, of the saw blade being only as thick as the thickness of the blade. As an alternative, the teeth 14 may have a slight outward bend or set, which will provide a cut or kerf of slightly greater width as so prevent possible binding of the blade. However, the additional kerf width will result in the generation of more dust during cutting and so is not used for applications where dust generation is to be kept to a minimum.

The notches 16 are generally square with approximately parallel sides 18. The bottom 20 of each notch 16 is generally parallel to the outer perimeter of the saw blade 10 so that the bottom 20 is generally perpendicular to the sides 18. The sides 18 of the notches 16 are generally perpendicular to the tangent of the saw blade circumference. The sides 18 of each of the notches 16 may also lie generally along the radius of the blade 10. In an embodiment of the blade 10 having a 4″ diameter (101.6 millimeters), the notches 16 are approximately 3 millimeters deep and 3 millimeters wide. The resulting teeth 14 are approximately 5 millimeters wide and 3 millimeters high.

The teeth 14 are generally square shaped with an outer edge 22 that has a length along the circumference of the saw blade 10. The outer edges 22 of the teeth 14 is concentric with the bottoms 20 of the notches. The teeth 14 have sides that are the sides 18 of the notches 16. The teeth 14 each have two corners 24 that are defined by the intersection of the outer edge 22 with the sides 18. The corners 24 are termed outer corners, whereas corners 26 that are formed by an intersection of the bottom 20 of the notch 16 and the sides 18 are termed inner corners.

Cutting of the wall board is performed by one of the outer corners 24 of each tooth 14 and possibly by a portion of the side 18 of each tooth 14. Since the teeth 14 are symmetrical about both rotation directions, the present saw blade 10 can be reversed to run in either direction. The blade 10 can be turned over on the power saw to present the other corner 24 and tooth edge 18 to the wall board as the cutting edge. As such, should the blade 10 become worn from use resulting in the corners 24 on one side of each tooth 14 being worn, the blade 10 is turned over and a fresh set of cutting corners 24 is presented. The blade thereby has an extended life by being able to be used in either direction.

The saw blade 10 may be formed by a variety of hard and durable material. For instances, stainless steel is contemplated as a material for forming the saw blades. In a preferred embodiment, the saw blade is formed of blued spring steel. The blade is formed by being punched from a sheet of the blued spring steel. Blued spring steel is very hard so there is little wear during use of the blade. But more importantly, blued spring steel may be formed quite thin while maintaining its strength and hardness. The result is a thin saw blade 10 that makes a cut that is very thin, so that little material is removed during cutting. This means that little dust is created by the cutting process.

Spring steel is also available in a variety of thicknesses and the present saw blade can be made in many different thicknesses by an appropriate choice of the steel thickness. For example, the material can be of a thickness of between 0.010 inches through 0.030 inches, or even 0.035 inches. Two thicknesses of blued spring steel that have been utilized in saw blades made according to the principles of the invention are of 0.015 inch thickness blued spring steel and 0.020 inch thickness blued spring steel. The blade formed of 0.015 thickness spring steel produces less dust during cutting than the thicker 0.020 thickness spring steel blade but tends to be somewhat flexible and so may not track true to the desired direction of cut for some users. The blade formed of 0.020 thickness blued spring steel tracks creates a bit more dust during cutting but tracks truer in the cut for some users than the 0.015 thickness blade. It is contemplated to use other thicknesses of material for blades or even other materials. The objective is to provide a blade that removes little material and so creates little dust, so the thinner the blade the better. On the other hand, tracking, strength or other attributes may lead to a somewhat thicker blade.

An advantage of using spring steel as the material for the blade is that it is a thin and strong yet inexpensive material so that the cost of the blade can be kept low. While blued spring steel may be somewhat brittle due to its hardness compared to other types of steel, it is sufficiently strong for forming the present saw blade and for use in cutting of wallboard.

In the preferred embodiment of FIG. 1, the circular saw blade 10 is a substantially planer, generally featureless disk except for the arbor hole 12 and the teeth 14 formed by the notches 16. In a second embodiment as shown in FIG. 2, a saw blade 30 has a central arbor hole 32 and teeth 34 formed by notches 36 as in the first embodiment. The second embodiment has one or more tabs 38 are cut from the disk at a predetermined spacing from the outer edge of the saw blade 30. The tabs 38 are the result of “U” shaped openings 40 being cut into the blade body. These tabs 38 are then deformed outward at an angle from the body of the saw blade 30, preferably being angled outward at about 45 degrees. In one embodiment, the tabs are bent alternately to each side of the blade 30. In another embodiment, the tabs can be all bent to one side of the blade 30 or with some to one side and some to another. The tabs 38 and the by U-shaped cutouts 40 are disposed at a distance from the edge of the blade 30 that is at or a little more than the thickness of the wallboard to be cut. When the blade 30 is set to the appropriate cutting depth, the outwardly bent tabs 38 cut a V-shaped cut into the wallboard at the cut formed by the saw blade. The V-shaped cut results in a beveled edge being formed on the wallboard at the cut edge. The beveled edge is formed in one step while the saw blade 30 is cutting the wall board. The beveled edge on the wallboard makes forming a finished seam on the wall easier while constructing wall surfaces.

If the tabs 38 are set back from the edge of the blade 30 by a distance greater than the thickness of the board to be cut, the blade can either be set to cut all the way through the board without forming a bevel at the edge or can be set to cut deeper to form a bevel while making the cut. Other spacing and arrangements of the tabs are of course possible.

The tabs 38 can be bent out to both sides of the blade 30 or can be bent out to only one side of the blade 30. If formed projecting from only one side, the tabs 38 will of course form a bevel cut only on one side. The blade 30 can include other projections to shape and form the drywall board during cutting, although such additional measures takes away a significant advantage of the preferred blade, that it is a very low cost item for manufacture.

In the illustrated embodiment of FIG. 2, six tabs 38 are provided in two groups of three. The first group of three tabs 38 has two tabs bent out to a first side of the blade 30 and one tab bent to the second side of the blade, while the second group of three tabs 38 has one tab bent to the first side and two tabs bent to the second side. The groups of tabs 38 are provided along the grain of the spring steel used to form the blade 10 so as to maintain the strength of the blade. In other words, the openings 40 are not cut into the blued spring steel in a way to weaken the blade excessively. Of course, other numbers or arrangements of the tabs 38 may be provided for forming the beveled edge on the wallboard. It is also contemplated to provide other structures, cutting elements or shapes of projections or cut outs to form a beveled edge during cutting of the wall board, or as a separate cutting step.

In FIG. 3, another embodiment of the saw blade 44 is provided. The illustrated saw blade 44 is for use in a circular saw and includes a central opening 46 for the saw arbor and teeth 48 at the perimeter thereof which are formed by notches 50. As with the embodiment of FIG. 1, the teeth 48 are approximately 5 millimeters across in the direction of the circumference of the blade 44 and approximately 3 millimeters in height in the radial direction of the blade. The notches 50 are approximately 3 millimeters by 3 millimeters, this being the preferred dimension on a 4 inch (approximately 101 millimeter) diameter saw blade.

The saw blade embodiment of FIG. 3 includes a plurality of circular holes 52 formed adjacent the perimeter of the blade 44. In the illustrated embodiment, 12 such holes 52 are provided a regularly spaced intervals around the blade and set back a short distance below the notches 50. Sufficient material is provided between the holes 52 and the notches 50 so as not to compromise the integrity of the saw blade 44. In an example of a 4 inch saw blade, the outermost edge of the holes 52 is about 1.5 mm below the inner most edge of the notches 50. Further, the holes 52 are disposed centered under the teeth 48 rather than being positioned under the notches to avoid weakening the structure of the blade.

The circular holes 52 of the illustrated embodiment are of a diameter approximately equal to the diameter of the central opening 46. This size is convenient since the punch for forming the central arbor opening 46 can also be used to form the holes 52. It is just as easy to form the holes of other sizes. Other shapes, sizes, numbers or arrangements of holes 52 are also possible in other embodiments of the saw blade.

The holes 52 are for friction reduction, weight reduction, and carrying the material, such as the gypsum dust, out of the cut being made. The holes 52 reduce the friction generated by the blade in the cut since there is less surface material of the blade to rub on the sides of the cut. It is important when cutting a thin cut, or kerf, since the sides of the cut remain tight against the blade. The reduced friction eases operation of the saw and reduces heat generated by the blade during movement in the cut.

The holes 38 reduce the weight of the saw blade 30 near the perimeter of the blade and thus reduce the inertia for starting and stopping the saw blade. As a result, the saw blade will more quickly come to speed when the saw is started and will more quickly come to a stop. Most power saws include a blade brake to stop the spinning blade after power is removed from the motor for the sake of safety. The lower the blade inertia, the more quickly the blade brake stops the blade. By reducing the inertia by including the holes 52, the embodiment of the saw blade shown in FIG. 3 comes quickly to a stop. Accidental cuts from the spinning blade are thereby reduced.

The holes 52 also carry away any material or dust as the board is being cut. The dust enters the holes 52 and is carried out of the cut and to a dust collector, as will be described later. This may keep the dust from spreading during operation of the saw.

The saw blade 44 of FIG. 3 with the holes 52 formed near the perimeter may be provided in two embodiment. In particular, it may have tabs 54 cut into the blade 44 to cut a beveled edge on the board during cutting. As with the previously described embodiment the tabs 54 may be provided in different arrangements and in different numbers and may be angled outward to one or both sides of the saw blade 44. In the second embodiment of the saw blade 44, no such tabs are provided and the blade is a plain sheet of metal between the holes 52 near the perimeter and the arbor hole 46.

It is contemplated to provide other arrangements of the holes 52 in the blade beyond what is shown. For instance, holes may be provided anywhere in the blade, including in multiple arrangements of holes between the central hole and the teeth, such as holes in concentric circles. The holes can be of any shape, including round, elongated, rectangular, etc.

The thin saw blade makes a thinner kerf of material which is removed during cutting so that less dust is generated by the saw. Saw blades typically have a so-called set to the teeth wherein the teeth are angled outwardly in opposite directions from the plane of the blade. In the present blade, little or no set is provided in the teeth so that the teeth lie substantially in line with the plane of the saw blade. The result is little dust generation during use.

Wallboard, or drywall, is available in standard thicknesses of one quarter inch, three eighths inch, half inch, and five eighths inch. The present saw blade of a preferred embodiment is in a size of four to four and one half inches in diameter, which is of a sufficient size to have a cutting depth to cut all standard thicknesses of wallboard and is even is capable of cutting a depth necessary for double layer wallboard. Utilization of a larger diameter blade would also require that the blade be formed of a thicker material for strength and thus make a thicker cut that generates more dust. As such, it is an advantage to keep the diameter of the blade smaller. The cutting depth of the blade can be set in the saw to cut either all the way through the wallboard or to cut just shy of the back surface of the wallboard so as to avoid striking wall studs and the like.

The teeth of the present saw blade have a depth and width of the gap to maximize the strength of the tooth enabling thinner materials to be used for the blade. Due to the symmetry of the teeth in the blade relative to the two rotation directions, the blade is reversible.

The size of the notch or gap cut into the perimeter of the saw blade to define the teeth may be set wider in some embodiments, however, this decreases the number of cutting edges possible on a blade.

The present saw blade is of a relatively inexpensive material so as to be disposable. The present blades can be manufactured by stamping from sheets of spring steel and require no further machining or forming. The present saw blades are inexpensive enough to offer several blades at a reasonable price to a casual user, such as a home owner doing a remodeling job on the house. For more regular users of the saw blades, such as contractors and construction workers, the saw blades may be provided in quantity.

Referring once again to FIG. 1, the teeth 14 of the present saw blade 10 have a generally circular outer edge 22 and cutting of the drywall material is provided by the corners 24 on each of the teeth 14 and by possible by a portion of the side 18 of the teeth. The circular outer edge 22 tends not to cut into wall joists, screws, nails and the like or at least not cut these things as readily as a more traditional saw blade. This avoids or reduces damage to the structural components of the building while cutting the wallboard in place. In testing, the saw blade stops its forward progress at or rides up on wall joists, nails or screws rather than cutting through them. Weakening of structural components is avoided. Use of the present circular saw blade to cut the wallboard facilitates cutting of the wallboard both prior to installation of the wallboard on the wall or ceiling as well as after installation of the wallboard on the wall or ceiling. Of course, wallboard can be installed on other places than walls or ceilings, such as banisters, room dividers, partition walls, etc. The present saw blade can be used to cut the wallboard in these places.

The present saw blade is particularly useful for forming so-called reveals in drywall construction. Reveals are openings that are cut into the wall and provided with decorative inserts, moldings and the like as decorative elements in the architecture. To insure proper installation, reveals should be cut into the wall after the wall has been installed. Since the present saw blade can cut the wallboard in place without requiring bending to complete the cut, and since little dust is generated during the use the present saw blade, the saw blade is particularly useful during installation of reveals. It is also beneficial to use the present saw to cut openings into walls for installation of, for example, plasma television screens and other fixture, while still maintaining the integrity of the structure.

Another area for use of the present invention is for demolition work, in other words the removing of existing structural elements such as is required prior to remodeling. Such work often takes place in an existing structure that may currently be in use, as opposed to a new construction prior to move in, so that dust generation can be a problem. With the present saw blade, dust generation can be kept to a minimum. Using the saw blade, old walls and structures can be taken down for remodeling projects and the like without damage to the supporting structure.

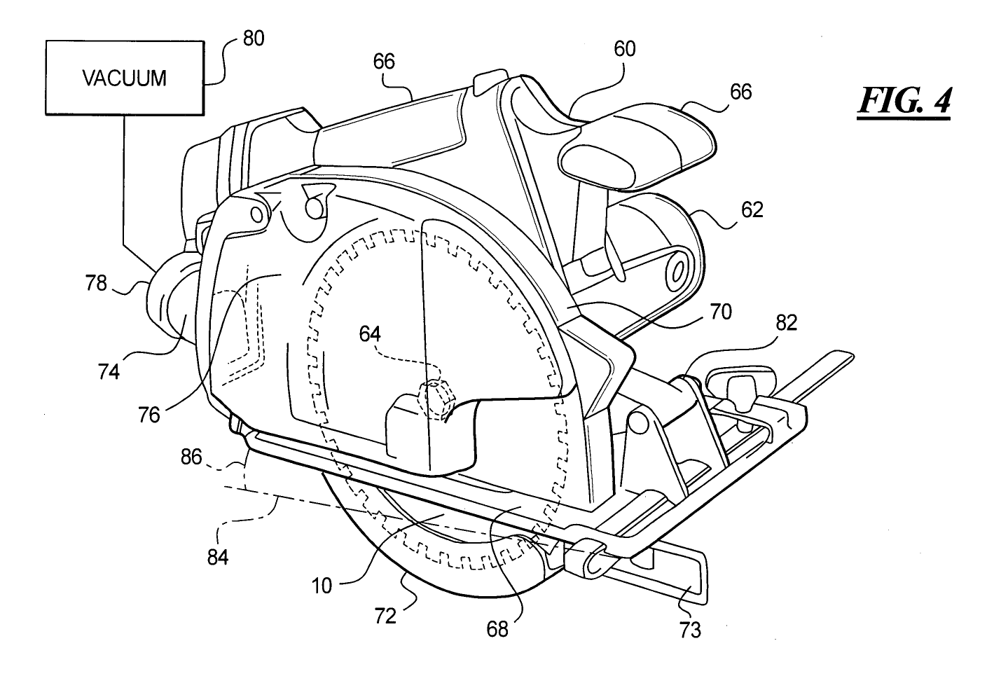

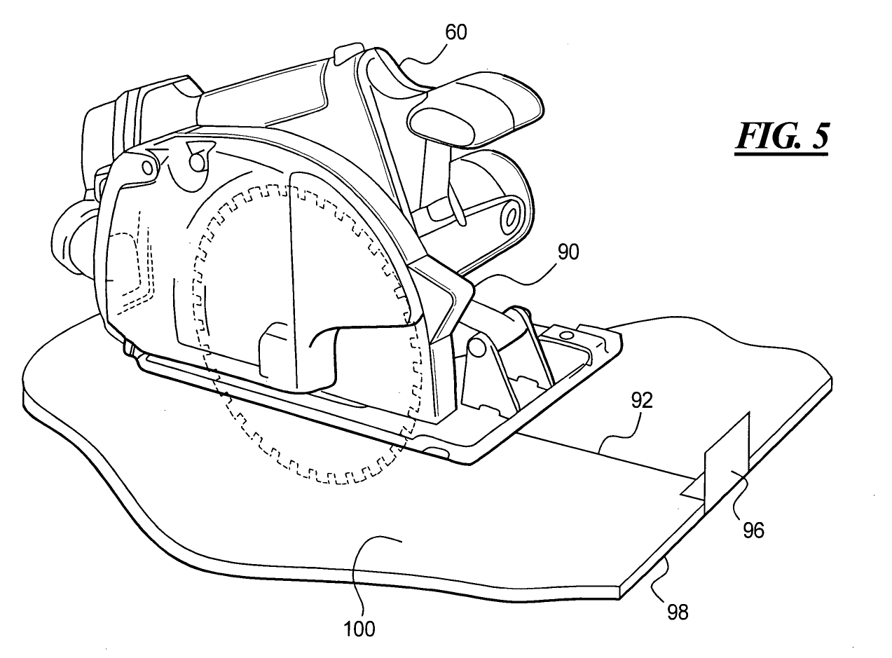

Turning to FIG. 4, the present saw blade 10 is used a power circular saw 60, such as a circular saw powered by line power or by battery power, to provide a relatively fast cut with a near factory finish at the cut edge. The power circular saw 60 includes a motor 62 that has an arbor 64 on which is mounted the saw blade 10. A handle 66 or possibly two handles 66 are provided by which the saw is held. A shoe 68 rests on the surface of the material being cut and a saw guard 70 to prevent accidental contact with the saw blade. The saw guard 70 typically has a retractable lower guard 72 that is pulled or pushed out of the way during use of the saw and that returns to a guard position when the saw is taken away from the material. A cutting guide 73 may be provided.

An important feature of the saw 60 is a dust collection system 74. The illustrated saw has a dust housing 74 as part of the saw guard 70 that encloses the upper portion of the blade 10. The dust collection system includes a dust repository 76 that collects the dust. The dust repository may have an air filter or cloth at 78 to permit air to escape without releasing the dust. It is also possible that the dust collection system includes a vacuum cleaner or other vacuum device 80 or power air flow filtration system. Any dust created during sawing and carried into the dust housing 74 is either collected inside the housing or carried away by the dust vacuum system 80.

Preferably, the shoe 68 of the saw has a slot or opening for the saw blade 10 through which the saw blade 10 extends that is sized to fit rather close to the blade. The close fitting shoe opening ensures that dust that is carried into the shoe 68 by the saw blade 10 is kept in the dust collection housing 74 or carried away by the vacuum system 80. In operation, the rotating saw blade carries dust generated by sawing through the cut in the wallboard and carries much of it back up into the dust collection housing 74. Generally, the dust that is not carried into the dust collection housing 74 remains in the cut and little dust is thrown or scattered by the saw, particularly as the result of the thin cut being made by the thin blade and the lack of a set, or outward angle, to the teeth 14.

In the preferred saw 60, the depth of the cut is adjustable by movement of the shoe 68 to expose more or less of the saw blade 10 through the slot in the shoe. The shoe 68 is generally held at a fixed location at one end, usually the front end, which is the pivot 82 in the illustrated saw. The shoe pivots about the fixed location 82 in an arc at the other end, usually the back end, of the shoe. In FIG. 4, the pivoted position of the shoe 68 is shown by a broken line 84. In many saw guards, the movement of the shoe moves the shoe away from the guard, exposing a gap at the base of the guard. The present saw 60 includes an extendable section 86 at the base of the guard 74 that moves with the shoe 68 and that maintains a dust tight seal with the shoe 68. This extension 86 closes any gap as the shoe 68 is moved to various blade depth positions and so keeps dust in the dust collection housing 74 at any blade depth position.

The present saw blade 10 facilitates cutting of the wall board in straight, even lines. While it is a generally accepted practice to mark the lines on the wall board prior to cutting, this adds an extra step to the cutting process and also introduces the possibility that the marking may be off the desired line. For example, marking the cutting line with a straight edge requires a long straight edge, requires that it be secured without movement during marking, and may require repeated marking along lines to be cut of greater length than the length of the straight edge. This may result in lines that are not straight over their length.

As shown in FIG. 5, to address this problem, the preferred saw includes a laser line tool 90 that is attached to the saw 60 and that generates a projected line 92 onto the wallboard 94 to be cut. The laser line tool 90 is attached to the saw body 60 in an aligned position so that it is aligned with the cut direction of the blade 10. Such laser line tools 90 are known. Here, it is possible to use such a laser line 90 on a saw 60 for sawing wallboard that has the low dust blade as described above. The laser line tool 90 projects the line 92 onto the work surface and the user of the saw 60 moves the saw along the line 92 for a straight cut that does not require marking, thus eliminating at least one step and providing a straighter cut than possible with may prior marking techniques.

The laser line tool 90 on the saw works best if the line 92 is directed along the desired cut. By marking only the end of the cut, the line 92 can be aimed at the end mark and the saw 60 can be moved to keep the line on the end mark to make a straight cut. If cutting is being performed over any substantial length, the user of the saw at one end of the wallboard sheet may not be able to see the end mark at the other end of the board clearly enough to maintain the laser line on the mark during cutting. For example, it is commonly necessary to cut 4 feet by 8 feet sheets of wallboard. A mark 8 feet away may not be easy to see for the user of the saw with the precision desired. Intermediate marking introduces possible errors in the marking and adds steps to the cutting process.

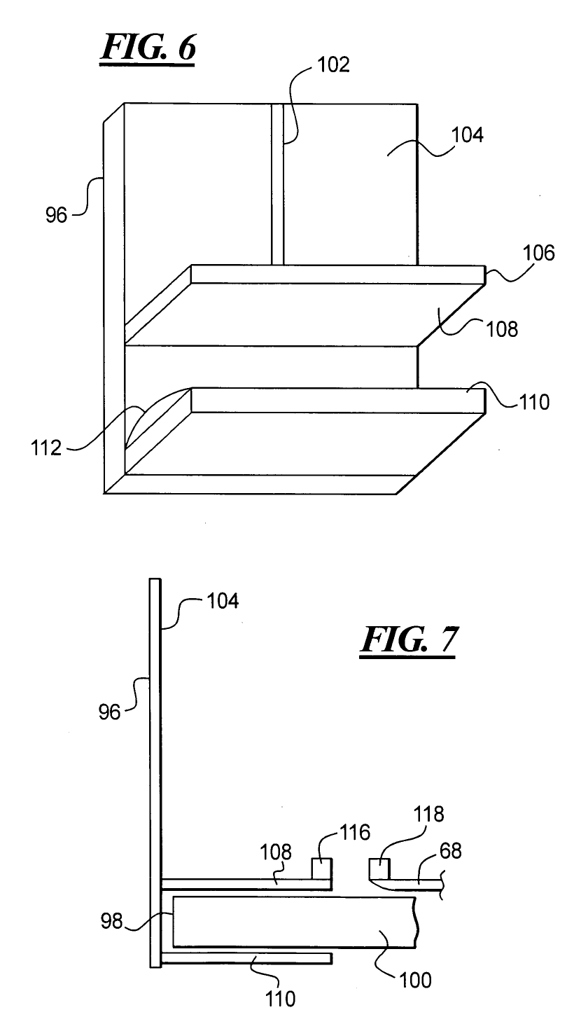

The present invention provides a laser line target 96 for the laser line. The laser line target 96 is of a sufficiently large size to be easily notice, is of a shape to enable clipping to an edge 98 of a sheet of wallboard 100 and has a target zone 102 indicated thereon to which the laser line 92 is directed during cutting. The laser line target 96 is shown in greater detail in FIG. 6. In particular, the target 96 has a planar target surface 104 that has a central line target zone 102 of a contrasting color, reflectivity, material or other surface characteristic so that the laser line 92 striking the target zone 102 is readily distinguished from the laser line striking a portion of the target to the side of the target zone. For example, the laser target may be a stripe of any of the coatings found on projection screens. The areas to the sides may be of a less reflective material or contrasting color.

The target 96 has a lower clip portion 106 that is shaped to engage an edge of a wall board sheet. For example, upper and lower grips 108 and 110 shaped and spaced to engage the top and bottom surfaces of the wallboard sheet are provided. To accommodate slight variations in thickness of the wall board sheets as well as to accommodate wallboards of different thicknesses, i.e. ⅜ inch, ½ inch, etc., the upper and lower grips may have springs 112 to bear against the wallboard so as to hold the target 96 in place. This prevents movement of the target 96 during handling of the wallboard, but particularly during the vibrations introduced by sawing.

The user of the present saw blade 10 and saw 60 with the laser line places the target 96 on the board at the desired end point of the cut and fastens it on the board edge. The saw 60 is placed at the desired starting point and the laser line tool 90 turned on to generate the laser cutting line 92. The laser line 92 projects on to the work surface and on to the laser target 96 when the saw is oriented correctly. Once the laser line 92 is on the target line 102, cutting can begin. The user achieves a straight cut by maintaining the position of the laser line on the laser target line 102.

Movement of the saw 60 toward the laser target during cutting must be halted before reaching the target 96 to avoid knocking the target 96 off the edge of the board 100. The target 96 is removed and then cutting resumes to finish the cut. As shown in FIG. 7, the present invention of a further embodiment eliminates these additional steps as the end of the cut by providing a magnet 116 on the target 96 at a position to engage the shoe 68 of the saw. Movement of the saw 60 against the target 96, releases the target 96 from the edge 98 of the board 100 and the magnet 116 holds the target 96 on to the shoe 68 so that the target 96 is held to the saw, preventing it from dropping off onto the floor.

It is foreseen that two or more magnets 116 may be provided along the width of the target 96. Preferably, a magnet target 118 is provided on the shoe 68 to engage the magnet 116 of the target 69 and ensure secure magnetic engagement so that it is held in the proper position. The magnet target 118 on the shoe 68 of the saw 60 can be magnetized itself or simply provide a ferromagnetic material portion for engagement with the magnet 116 of the laser target.

The target 96 and/or shoe may be shaped to prevent it from swinging down into the path of the saw blade when engaged with the shoe. A mechanical engagement may be used in place of the magnetic engagement 116.

The user of the saw 60 and laser target 96 can measure the intended cut only at the two opposite edges of the wallboard, for example, install the laser target 96 on the measurement mark on the first edge and then begin cutting from the second edge to the first edge. The laser target 96 may include a cut out notch in the top clip 108, a transparent portion of the top clip 108 or other means to enable easy alignment with the mark. The laser line cutting guide and laser target insures a straight cut, the magnetic catch 116 on the laser target ensures that the user does not have to stop cutting until the cut is complete. The thin blade 10 ensures that the cut surface is smooth and is generated with little dust. The user even has the option of forming a bevel on the edge of the cut surface by using a blade with the bevel forming tabs 40. Construction projects are made quicker, cleaner and less prone to error by the present cutting system.

The laser target 96 need not be used only with the wallboard saw blade 10, but can be used for a variety of laser aiming tasks. For example, the target may be used with wood saws, or other power saws, levels, planes, and a wide variety of power tools and other devices.

The saw blade of the present invention may be used on power tools other than a full size circular saw. For example, a small version of the saw blade can be used on a small power hand tool. Examples of such small hand tools are made by Dremel and Rotozip. The saw blade may be mounted on the motor shaft, on a angled shaft or on a flexible shaft as desired. The saw blade will produce less dust than other types of saw blades or rasping or filing tools and so could be used without dust shielding. However, the addition of dust shielding to the small hand tool to prevent the spread of dust provides great advantage. The cut provided by the present blade has a finer finish and so requires little or no working to make the finished product. Various hand saws, cutting tools and shaping tools may utilize a saw blade according to the invention.

Although other modifications and changes may be suggested by those skilled in the art, it is the intention of the inventors to embody within the patent warranted hereon all changes and modifications as reasonably and properly come within the scope of their contribution to the art.

1. A saw blade for a circular power saw for cutting drywall board, comprising:
a blade body of a thin and hard material, said blade body having a generally circular shape, said blade body defining a central opening for accepting an arbor of a power saw; and
a plurality of teeth formed along a perimeter of said blade body, said teeth being of a generally rectangular shape and having an outer edge of each of said teeth having an edge lying substantially along a circle centered on said central opening, said teeth being separated from one another by a plurality of notches, said teeth lying in a plane with said blade body.

2. A saw blade as claimed in claim 1, wherein said notches are substantially square.

3. A saw blade as claimed in claim 1, wherein said material of said blade body is blued spring steel.

4. A saw blade as claimed in claim 1, wherein said blade body is of a thickness in a range of about 0.010 inch through about 0.030 inch.

5. A saw blade as claimed in claim 4, wherein said blade body is of a material having a thickness of about 0.015 through about 0.020 inches.

6. A saw blade as claimed in claim 1, further comprising: a plurality of bevel cutting elements extending from at least one side of said blade body spaced by a predetermined distance from a perimeter of said blade body.

7. A saw blade as claimed in claim 1, wherein said blade body has a diameter of approximately 4 inches, said blade body has a thickness of approximately 0.015 through 0.020 inches, and approximately 36 teeth are formed in the perimeter of said blade body.

8. A power saw for sawing drywall board and the like, comprising:
a motor having an arbor;
a circular saw blade mounted on said arbor of said motor, said circular saw blade being formed of spring steel and having saw teeth formed along a perimeter of said circular saw blade, said saw teeth each having an outer edge lying substantially along a circle centered on said arbor, said outer edge extending to two opposite sides of the saw tooth, said sides being substantially parallel with one another and lying generally along a radius of the circle, said teeth lying in a plane of said circular saw blade;
a shoe on said power saw having an opening through which a first portion of said circular saw blade extends; and
a dust collecting housing enclosing said arbor and a second portion of said circular saw blade, said dust collecting housing extending to said shoe.

9. A power saw as claimed in claim 8, wherein said shoe is adjustable to vary an extent of said circular saw blade extending through said opening of said shoe to vary cutting depth of said power saw, and further comprising:
a compressible connection between said shoe and said dust collecting housing to accommodate movement of said shoe relative to said dust collecting housing and keep a substantially dust tight connection therebetween.

10. A power saw as claimed in claim 8, further comprising:
a laser line projector on said power saw;
a laser target for connection to a portion of a drywall board to be cut, said laser target having a portion engagable with said power saw to hold said laser target on said power saw upon said power saw reaching a position of said laser target on the drywall board.

11. A power saw as claimed in claim 10, wherein said laser target includes a magnet for magnetic engagement with said power saw.

12. A method for cutting drywall board, comprising the steps of:
providing a circular power saw with a saw blade having saw teeth lying in a plane of said saw blade;
mounting a laser target to an edge of the drywall board;
aligning a laser line of a laser line projector on the circular power saw with the laser target;
cutting the drywall board toward the laser target sufficiently to disengage the laser target from the drywall board;
engaging the laser target with said circular power saw upon disengagement of the laser target from the drywall board.

13. A method as claimed in claim 12, wherein said engaging step includes magnetic engagement between the power saw and the laser target.

14. A saw blade as claimed in claim 1, wherein said blade body defines a plurality of openings formed in said blade body, said openings being disposed between said central opening and said teeth.
